(19) United States
(12) Patent Application Publication
(10) Pub. No.: US 2015/0027401 A1
(43) Pub. Date: Jan. 29, 2015

(54) PISTON AND CONNECTING ROD FOR AN INTERNAL COMBUSTION ENGINE

(71) Applicant: Volker Gniesmer, Alfed (DE)

(72) Inventor: Volker Gniesmer, Alfed (DE)

(73) Assignee: KS KOLBENSCHMIDT GMBH, Neckarsulm (DE)

(21) Appl. No.: 14/354,789

(22) PCT Filed: Aug. 3, 2012
(86) PCT No.: PCT/EP2012/065209

§ 371 Date: Aug. 13, 2014

(30) Foreign Application Priority Data
Oct. 28, 2011 (DE) 102011085448.7

(51) Int. Cl. F02F 3/00; F02F 3/02

(52) U.S. Cl. CPC F02F 3/0069; F02F 3/02
USPC 123/197.3; 123/193.3

(57) ABSTRACT

The invention relates to a piston (1) of an internal combustion engine, which piston (1) has a piston head (2) with a ring field (3) and a skirt part which is arranged on the piston head (2), wherein the skirt part has at least two load-bearing skirt-wall sections (4a, 4b), and the load-bearing skirt-wall sections (4a, 4b) are connected to one another via at least two obliquely positioned box walls (5) which are set back with respect to the piston external diameter. In each case one pin boss (9) for receiving a piston pin is arranged in the box wall (5) and one skirt-wall section (4a) forms the pressure side and the other skirt-wall section (4b) forms the counter-pressure side. According to the invention that the inner surface of the pin boss (9), in relation to the piston centre, runs flushly with respect to the surface of the associated box wall (5), and the box wall (5) has a concave profile in the transverse extent with respect to the direction of the pin boss (9). Furthermore, the invention relates to a connecting rod of an internal combustion engine.

### BACKGROUND

The disclosure relates to a piston of an internal combustion engine, which has a piston head with a ring zone and a skirt section attached to the piston head The disclosure further relates to a connecting rod of an internal combustion engine having a connecting rod to receive a piston pin.

A piston is known from DE 101 45 589 B4 that has a piston head, ring zone and a piston skirt consisting of load-bearing skirt wall sections and recessed connecting walls that connect the skirt wall sections to each other and, in the direction of a piston pin axis, to piston pin bosses recessed from a piston axis that pass through the connecting walls. The connecting walls in this piston are configured convex to an axis in the region of their peripheral lower edge, and in the region of their upper edge below the ring zone concave to the axis, where the width of the skirt wall sections at the lower edge correspond approximately to the width of the skirt wall sections below the ring zone.

Pistons of this type known from the prior art are subject to high mass force load because of the high rpm during operation in an internal combustion engine. Reducing piston weight as a result of design measures leads to a reduction of the oscillating mass during operation in an internal combustion engine, which also reduces the mass force load on the component. However, because of this reduction in weight in the piston, there is a disadvantageous reduction in stiffness in the piston, which has a negative effect on the operating characteristics of the piston in an internal combustion engine and a negative effect on the wear and strength characteristics of the piston.

It will be desirable, to reduce the weight of the piston in such a way that, at the same time, adequate stiffness in the piston is retained. It is further desirable to develop a connecting rod for use with a weight-optimized piston of this kind, possessing a high degree of stiffness.

### SUMMARY

The internal surface of the piston pin boss running flush with the surface of the associated box wall with regard to the piston center and the box wall follows a concave path perpendicular to the direction of the piston pin boss. Flush means that the piston pin boss facing the piston center is an integral part of the box wall, and that the piston pin boss is bounded by the box wall, where the piston pin boss does not protrude from the box wall towards the piston center. The connecting rod has a shape to which the concave progression of the respective box wall is adapted.

It is advantageous in a piston of this type that the weight of the piston is reduced, while at the same time adequately high stiffness in the piston is achieved by the path of the box wall and the arrangement of the piston pin boss in the piston. Furthermore the force intervals in the oscillating mass forces and gas forces are advantageously reduced, resulting in a reduction in support spacing for the piston pin reaction forces. In addition, the stress from mass forces is reduced by the piston. Furthermore, the piston has great resistance to seizing, optimal guidance and adequate support when operating in an internal combustion engine. These effects are amplified and improved by matching the piston to the connecting rod design.

In an embodiment of the piston, the two box walls follow a concave, such as a minor-image matching concave, progression such that as a result of the two box walls an almost uniform X-shape results so that an approximately symmetrical piston results. The X-shape is created by each respective box wall forming one side of the X, where the box walls do not contact each other even at the contact point of the two legs of the X.

In a further embodiment of the piston, the two box walls have a concave progression such that an approximately unequal X-shape results from the two box walls so that an asymmetrical piston results.

In a further embodiment of the piston, the respective section angle between pressure side and counter-pressure side formed from the skirt wall section is the same so that as a result a uniform progression of the X-shape of the box walls results and thus an approximately symmetrical piston results. The piston has two skirt wall sections of which one skirt wall section forms the pressure side and one skirt wall section forms the counter-pressure side. The section angle of the pressure side and of the counter-pressure side is measured in each case between the two contact points of the associated box walls with regard to the stroke axis of the piston. The stroke axis of the piston runs through the center of the piston in the direction of the piston stroke in the internal combustion engine.

In a further alternative embodiment of the piston, the section angles between pressure side and counter-pressure side of the piston are different so that an asymmetrical piston results. With unequal section angles between pressure side and counter-pressure side formed by the skirt wall section, the result is an unequal progression of the X-shape of the box walls. With unequal section angles of this kind an asymmetrical piston results.

In a further embodiment of the piston, the dimensions of the skirt wall sections are identical so that an approximately symmetrical piston results. With identical dimensions for the skirt wall sections of pressure side and counter-pressure side, the result is an approximately symmetrical piston.

In a further alternative embodiment of the piston, the dimensions of the skirt wall sections are different so that an asymmetrical piston results. The skirt wall section on the pressure side and the skirt wall section on the counter-pressure side differ in an asymmetrical piston in that the one skirt wall section, viewed from the piston head towards the stroke axis and connecting rod, that is to say, towards the underside of the piston, has at least a different dimension compared with the other skirt wall section. As an alternative or a supplement, in an asymmetrical piston the one skirt wall section viewed towards the path of the skirt wall section has at least a different dimension compared with the other skirt wall section.

In a further embodiment of the piston, the thickness of the skirt wall sections between pressure side and counter-pressure side is identical so that the result is an approximately symmetrical piston. The thickness of the skirt wall sections refers to a plane that is located perpendicular to the stroke axis.

In a further alternative embodiment of the piston, the thickness of the skirt wall sections between the pressure side and the counter-pressure side is different so that the result is an asymmetrical piston. With the skirt wall sections of unequal thickness between the pressure side and the counter-pressure side with regard to a plane perpendicular to the stroke axis, the result is an asymmetrical piston.

In a further embodiment of the piston. the width of the box wall between pressure side and counter-pressure side is the same, so that an approximately symmetrical piston results. An approximately symmetrical piston results from the matching mirror-image sides with regard to a minor plane. The mirror plane is formed by a plane that is drawn through the stroke axis and axis of the piston pin boss and an additional plane, where the additional plane is drawn through the stroke axis and a perpendicular axis, where the perpendicular axis runs perpendicular to the stroke axis and perpendicular to the axis of the piston pin boss.

In a further alternative embodiment of the piston, the width of the box walls between the pressure side and the counter-pressure side is different, so that the result is an asymmetrical piston. In an asymmetrical piston, the width of the one box wall can vary compared with the other box wall in a mirror image with regard to the mirror plane between the pressure side and the counter-pressure side towards the stroke axis. Alternatively or as a supplement, it is possible in the case of an asymmetrical piston that the width of the particular box wall varies between the pressure side and the counter-pressure side compared with the other box wall towards the perpendicular axis.

In a further embodiment of the piston, the piston pin boss protrudes from the associated box wall towards the outside of the piston. As a result, one part of the piston pin boss is formed by the box wall itself. The piston pin boss is consequently an integral part of the box wall, where the piston pin boss does not protrude towards the inside of the piston, that is to say the middle of the piston, and the box wall with the piston pin boss forms a single continuous surface with regard to the inside of the piston. The box wall assumes the same shape as the piston pin boss surface in the area of the center of the piston. The main body of the respective piston pin boss extends out of the associated box wall itself towards the outside of the piston.

In a further embodiment of the piston, the piston pin boss protrudes from the box wall on the opposite side of the piston head at the box wall. As a result, one part of the piston pin boss extends out of the box wall in the area of the underside of the piston.

In a further embodiment of the piston, on the opposite side of the piston head the surface of the box wall, towards the outside of the piston at the box wall, has a collar that reinforces the box wall to absorb lateral forces. A collar of this kind can have a round, oval, drop-shaped and/or any other form.

In a further embodiment of the piston, the collar has identical dimensions perpendicular to the direction of the path of the piston pin boss and parallel to the path of the box walls so that the result is identical collar shapes between the pressure side and the counter-pressure side, resulting in an approximately symmetrical piston. Using a path perpendicular to the direction of the path of the piston pin boss and parallel to the path of the box walls, a path is defined using which the respective box wall will pass through from one side of the box wall, for example the side in the area of the pressure side, to the opposite other side of the same box wall, for example, the side in the area of the counter-pressure side. Alternatively, a reverse path from the side in the area of the counter-pressure side towards the side in the area of the pressure side is also possible.

In a further alternative embodiment of the piston, the dimensions of the collar perpendicular to the direction of the path of the piston pin boss and parallel to the path of the box walls are different so that the result is an asymmetrical piston. With unequal dimensions for the collar of each box wall side perpendicular to the direction of the path of the piston pin boss, the result is an asymmetrical piston as a result of the unequal collar shape of the respective box wall. Alternatively or as a supplement, the collar of the one box wall can be shaped differently from the collar of the other box wall in the corresponding area so that the result is an asymmetrical piston.

In a further embodiment of the piston, the piston head has at least one undercut running partially around the piston that is reinforced by at least one rib. An undercut of this kind running partially around the piston results in a weight reduction in the piston and, because of the at least one rib in the at least one area of the partially circumferential undercut, great stiffness is achieved in the piston at the same time. A partially circumferential undercut in the area of the piston head runs around a single box wall of the piston, where the undercut is located relative to the box wall towards the outside of the piston. The partially circumferential undercut can have an elongated, oval, round, drop-shaped and/or any other shape. The rib can have the shape of a bead, a wall, a seam or similar.

It is possible that the rib is located solely in the area of the partially circumferential undercut. It is additionally possible that a rib is also located outside the area of the partially circumferential undercut. The rib outside the area of the partially circumferential undercut has the identical or alternatively, a corresponding shape as the rib that is located in the area of the partially circumferential undercut. Particularly the rib located in the area of the partially circumferential undercut blends into the rib located outside the area of the partially circumferential undercut so that in this way a single rib is formed in the piston.

In a further embodiment of the piston, the rib runs in a wave-shaped, such as a sinusoidal wave-like line towards the path of the piston pin boss parallel to the path of the piston head. A line towards the path of the piston pin boss is a line that runs perpendicular to the connecting axis between the pressure side and the counter-pressure side of the piston. A line parallel to the path of the piston head defines a line to a plane that runs parallel to the surface of the top side of the piston in the area of the piston head. A wave form is understood to be a line that, when viewed towards the path of the piston pin boss parallel to the path of the piston head, is characterized in that the edge of the rib has peaks and valleys parallel to the piston head as it moves towards the piston pin boss, which peaks and valleys may be equally and/or differently pronounced. Furthermore, a wave-shaped line of this type may be periodic or aperiodic. A sinusoidal, wave-like line is also known by the term omega-shaped line. When the rib in the piston runs symmetrically, the result is a symmetrical piston.

In a further embodiment of the piston, the rib follows a wave-shaped, preferably a sinusoidal, wave-like path towards the line of the piston pin boss perpendicular to the path of the piston head. A path perpendicular to the line of the piston head defines a path to a plane that runs perpendicular to the surface of the top side of the piston in the area of the piston head. A wave shape towards the line of the piston pin boss perpendicular to the line of the piston head is understood to be a path which, when viewed towards the line of the piston pin boss perpendicular to the line of the piston head is characterized in that the edge of the rib as it moves towards the piston pin boss has peaks and valleys perpendicular to the piston head, which peaks and valleys may be equally or differently pronounced. Furthermore, a wave-shaped line of this type may be periodic or aperiodic. When the rib in the piston runs symmetrically, the result is a symmetrical piston.

In a further alternative embodiment of the piston, the path of the rib towards the line of the piston pin boss perpendicular and/or parallel to the line of the piston head is varied so that the result is an asymmetrical piston. For example, the path of the rib is asymmetrically wave-like, preferably asymmetrically sinusoidal wave-like in an asymmetrical piston.

In a further embodiment of the piston, the rib has the same dimensions along its path so that the result is an approximately symmetrical piston. The dimensions of the rib refer to the length of the rib referred from the piston head towards the connecting rod, i.e. the underside of the piston, and/or to the thickness of the rib with regard to a plane perpendicular to the stroke axis. An approximately symmetrical piston consequently results from the length of the rib and/or the thickness of the rib at corresponding areas in the piston being the same. Alternatively, or as a supplement, an approximately symmetrical piston results when there are several ribs, and the ribs are identical to each other in the corresponding areas.

In a further alternative embodiment of the piston, the dimensions of the rib are different along its path between pressure side and counter-pressure side so that the result is an asymmetrical piston. An asymmetrical piston consequently results because the rib has unequal dimensions along its path. Alternatively, or as a supplement, an asymmetrical piston results from a variation in the dimensions of several different ribs in a piston.

In a further embodiment of the piston, the thickness of the rib in its path between the pressure side and the counter-pressure side is the same so that the result is an approximately symmetrical piston.

In a further alternative embodiment of the piston the thickness of the rib in its path between the pressure side and the counter-pressure side is different so that the result is an asymmetrical piston.

In a further embodiment of the piston, the at least one connection from the area of the ring zone to the area of the piston head is the same so that the result is an approximately symmetrical piston. The connecting area is an area between ring zone and piston head area of the piston, where this area refers to the back wall of the ring zone area and piston head area. The connecting area is suitably designed to control the various lateral forces on the piston and/or the deformation of the piston during operation in an internal combustion engine. The connection in the connecting area preferably has at least one radius and/or at least one specific dimension.

In a further alternative embodiment of the piston, the at least one connection from the area of the ring zone to the area of the piston head is different so that the result is an asymmetrical piston. With an asymmetrical piston, the connecting area, for example, on the side of the pressure side of the piston is configured larger in its dimensions, that is to say, thicker than the connecting area on the side of the counter-pressure side so that as a result the lateral forces acting on and/or distortion of the piston occurring during piston operation can be better controlled. Alternatively, or as a supplement, it is, for example, also possible to change the radius of the connection in the connecting area so that the result is also an asymmetrical piston.

In a further embodiment of the piston, the piston includes of at least two components where one component has at least a piston head and the other component has at least the box walls, where the area between the box walls and the piston head has at least one type of connection. A two-part piston of this type can, for example, be joined using a friction weld connection, threaded connection, press fit and/or similar.

In a further embodiment of the piston, the internal shape of the piston can be produced using a single-piece core, specifically it can be cast. As a result, particularly simple and rapid production of the internal shape of the piston is possible, using casting, for example, by casting the internal shape directly at the same time using a single-piece formable core while the complete piston is being cast.

The connecting rod in an embodiment has a trapezoidal shape in the area of the eye of the connecting rod, where said eye receives the piston pin. The shape of the connecting rod determines the shape and location of the respective box wall in the piston.

The connecting rod can have two eyes of which the eye with the smaller dimensions receives the piston pin. The connecting rod has a trapezoidal shape in the area of the smaller eye.

In a further embodiment of the piston, the angle of the trapezoidal shape of the connecting rod extends between 8° and 25°, preferably between 15° and 20° per side of the trapezoid.

### BRIEF DESCRIPTION OF THE DRAWING

An embodiment is shown in the four Figures in which:

FIG. 1 shows a section of a piston in a side cross-section view;

FIG. 2 shows a section of the piston viewed from the connecting rod looking towards the piston head seen in section A-A;

FIG. 3 shows a section of the piston in a viewed from the connecting rod looking towards the piston head seen in section B-B; and

FIG. 4 shows a simplified representation of the path of the ribs and box walls in the piston.

### DETAILED DESCRIPTION

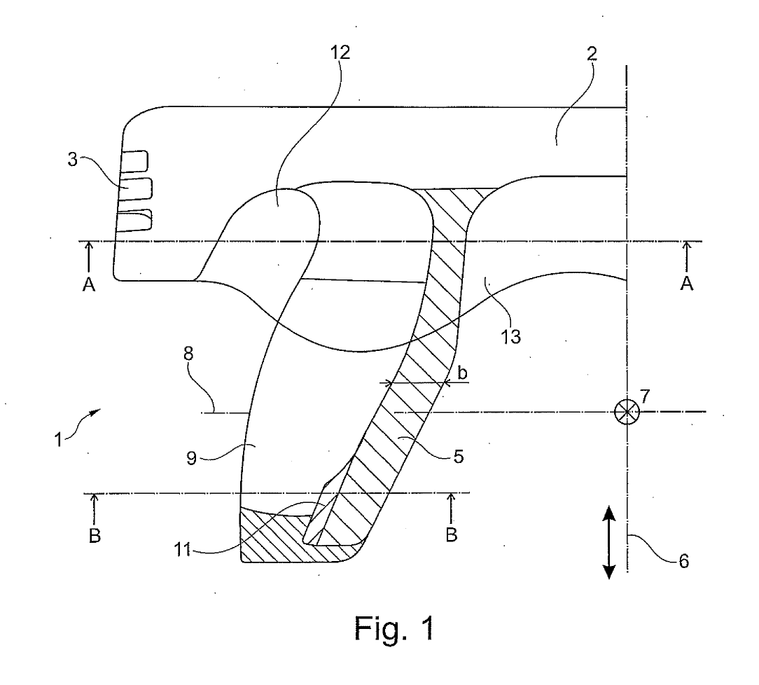

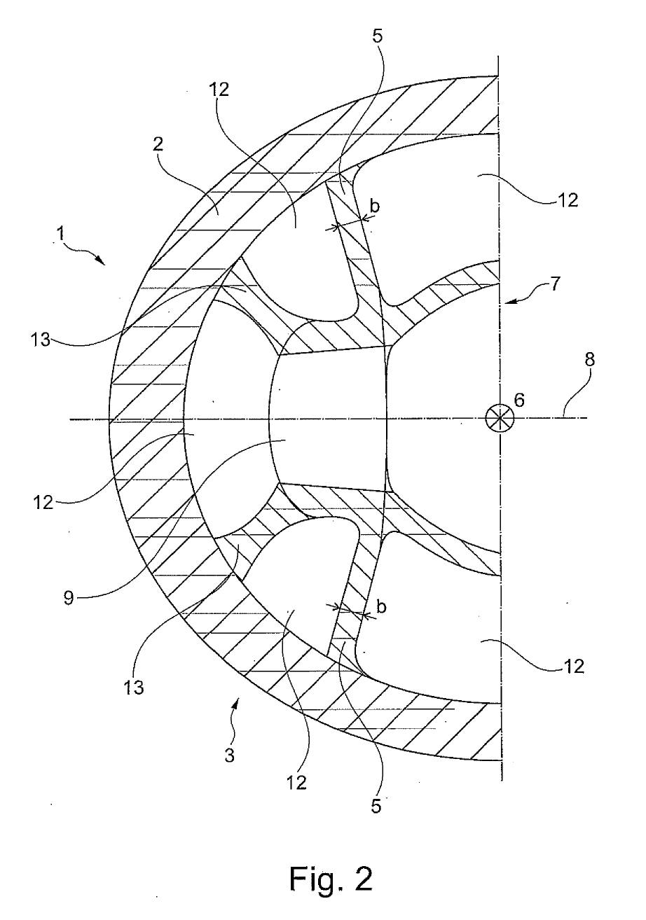

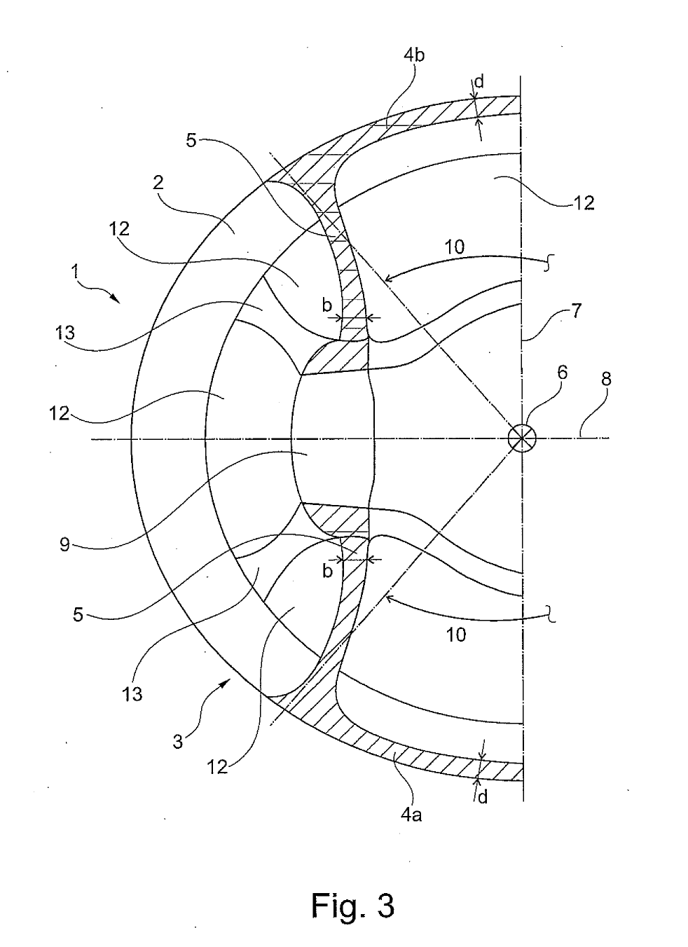

Only one side of a piston 1 of an internal combustion engine is shown in 1 to 3 as a simplified section. In accordance with FIGS. 1 to 3, only the left side of the piston 1 is shown. In accordance with FIG. 1, the piston 1 is shown in a side view as a cross-section, where the section plane runs through a stroke axis 6 of the piston. In accordance with FIGS. 2 and 3, the section A-A and the section B-B run through a plane that stretches from a piston pin axis 8 and a transverse axis 7 of the piston 1 and is shifted parallel thereto. The transverse axis 7 runs perpendicular to the piston pin axis 8 and the stroke axis 6. In the embodiment the piston 1 is configured as a piston for a spark-ignition internal combustion engine, where the piston 1 is configured as a one-piece component.

In accordance with FIG. 1, the piston 1 has a piston head 2. The piston head 2 of the piston 1 has a ring zone 3 that completely encircles the piston 1 (shown in simplified form). In accordance with FIG. 1, the piston 1 in this embodiment has identical connections in the area of the rear wall from the area of the ring zone 3 to the area of the piston head 2 viewed across the circumference of the piston 1. The connecting area 14 is the area between the respective rear wall of ring zone 3 and piston head 2. In the embodiment in FIG. 1, the connection in the connecting area 14 is configured as a radius.

In FIG. 3, the piston 1 has a skirt component attached to the piston head 2, where the skirt component has two load-bearing skirt wall sections 4a, 4b. The one skirt wall section 4a forms the pressure side and the other skirt wall section 4b forms the counter-pressure side.

In accordance with FIGS. 1 to 3, the two load-bearing skirt wall sections 4a, 4b are connected to each other via two oblique box walls 5 recessed relative to the piston outside diameter.

A piston pin boss 9 is located in the respective box wall 5 to receive a piston pin (not shown). In accordance with FIGS. 1 to 3, the inside surface of the pin boss 9 with regard to the piston center, that is, the stroke axis 6 runs flush with the associated box wall 5. In accordance with FIGS. 1 to 3, the respective pin boss 9 is restricted in the direction of the piston center, that is, towards the stroke axis, by the associated box wall 5, where the pin boss 9 does not protrude from the associated box wall 5. The pin boss 9 is thus an integral component of the associated box wall 5 in the direction of the center of the piston 1.

In FIG. 1, the pin boss 9 protrudes from the associated box wall 5 towards the outside of the piston. Furthermore, according to FIG. 1, the pin boss 9 protrudes at the box wall 5 from the directly opposite side of the piston head 2, that is, from the piston head 2 towards the connecting rod with regard to the direction of the stroke axis 6, from the box wall 5. The pin boss 9 consequently projects at the associated box wall 5 from the box wall at the underside of the piston in accordance with FIG. 1.

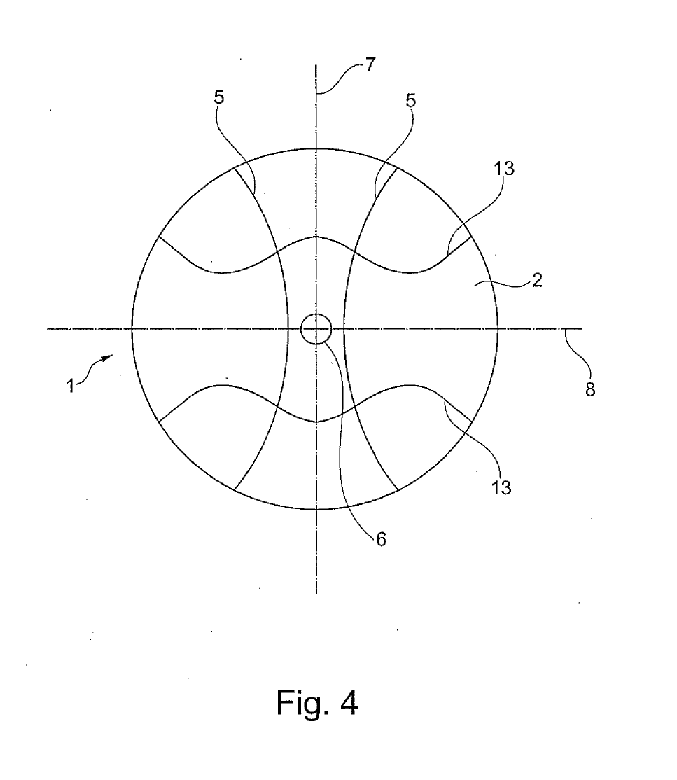

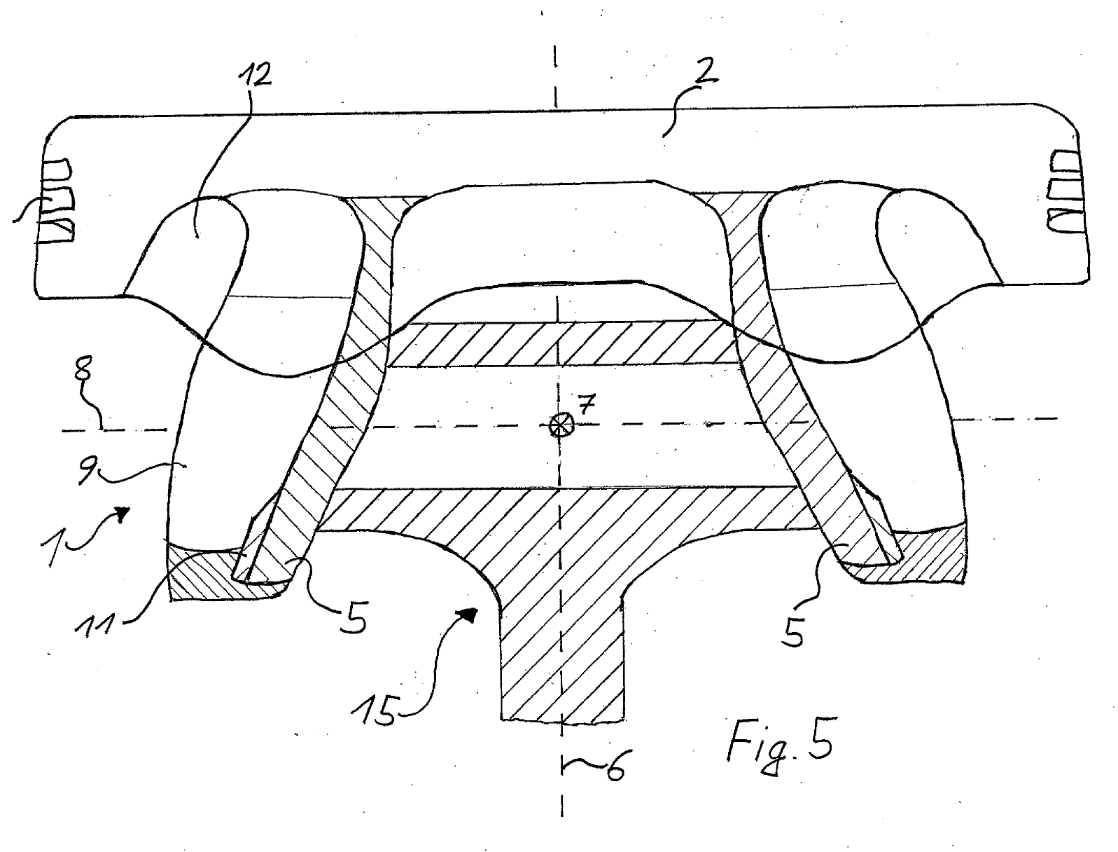

Further, in accordance with FIGS. 2 and 3, the box wall 5 follows a concave path as it runs perpendicular to the direction of the pin boss 9, that is, perpendicular to the pin axis 8, and vertical to the stroke axis 6. The two box walls 5 follow a matching mirror-image path such that an approximately uniform X-shape is created by the two box walls 5 in accordance with FIG. 4. The result is an approximately symmetrical piston 1.

In accordance with FIGS. 1 to 3, the width b of the box walls 5 between the pressure side and the counter-pressure side is identical so that the result is an approximately symmetrical piston 1.

In accordance with FIG. 1, on the opposite side of the piston head 2, that is, viewed from the piston head 2 towards the connecting rod with regard to the stroke axis 6, the surface of the box wall 5 has a collar 11 towards the outside of the piston on the box wall 5 that reinforces the box wall 5 to absorb lateral forces. The collar 11 is located in the area of the underside of the piston.

The collar 11 has the same dimensions perpendicular to the direction of the pin boss 8, that is, towards the transverse axis 7 and parallel to the path of the box walls 5, so that identical collar shapes result between the pressure side and the counter-pressure side which also results in a symmetrical piston.

In accordance with FIG. 3, the respective section angle 10 formed from the skirt wall section 4a, 4b between the pressure side and the counter-pressure side is identical so that the X-shape follows a regular path and thus an approximately symmetrical piston results. The section angle 10 is drawn between the stroke axis 6 and the contact points between respective box wall 5 and respective skirt wall section 4a, 4b in accordance with FIG. 3. The dimensions of the two skirt wall sections 4a, 4b with regard to the piston head 2 in the direction of the connecting rod with regard to the stroke axis 6 are identical so that an approximately symmetrical piston 1 results. In accordance with FIG. 3, the thickness d of the two skirt wall sections 4a, 4b between pressure side and counter-pressure side is identical so that an approximately symmetrical piston results. The X-shape of the two box walls is formed in accordance with previous explanations in the area from about the ring zone 3 to the underside of the piston.

In accordance with FIG. 1, the piston head 2 has two undercuts 12 running partially around the piston 1. In the embodiment, the two undercuts 12 in the piston head run at a constant radius around the stroke axis 6 radially in the area of the outside of the piston around the appropriate box wall 5. Thus, the respective partially circumferential undercut 12 is located only around the appropriate box wall 5 in the area of the outside of the piston in accordance with FIGS. 2 and 3 in the piston 1.

The piston 1 furthermore has two ribs 13 that reinforce the two partially circumferential undercuts 12 in the piston head 2 and interrupt the particular orbit of the partially circumferential undercut 12 by means of the particular rib 13 in accordance with FIGS. 2 and 3. In addition, the particular partially circumferential undercut 12 is bounded in its orbit by the appropriate box wall 5 in accordance with FIGS. 2 and 3. In accordance with FIGS. 1, 2, 3 and 4, the ribs 13 are located in the area and additionally outside the area of the partially circumferential undercut 12 matching each other. The two ribs 13 illustrated in FIGS. 2 and 3 have identical dimensions along their path so that an approximately symmetrical piston results. In FIGS. 2 and 3, a thickness k for the two ribs is shown. The thickness k of the respective rib 13 is the same along its path between the pressure side and the counter-pressure side so that an approximately symmetrical piston results.

In the accordance with FIG. 2 and FIG. 3, the ribs 13 have towards the line of the pin boss 9, that is, in the direction of the pin axis, parallel to the line of the piston head 2, a somewhat sinusoidal, wave-like path, which is also periodic in the embodiment.

Furthermore, the ribs 13 in accordance with FIG. 1, have a somewhat sinusoidal, wave-like path towards the path of the pin bosses 9, that is, towards the pin axis, perpendicular to the line of the piston head 2. This pronounced sinusoidal, wave-like path is periodic. The path perpendicular to the piston head 2 refers to the direction of the stroke axis 6.

In FIG. 4, the piston 1 is shown simplified for purposes of clarification in a view from the underside of the piston towards the piston head 2 with regard to the stroke axis 6 so that the somewhat sinusoidal, wave-like path of the two ribs 13 with regard to the two box walls 5 and the piston head 2 becomes clear. Further, the X-shape of the concave box walls 5 becomes clear.

The somewhat symmetrical piston 1 shown in FIGS. 1 to 4 can, for example, also be configured as an asymmetrical piston as the result of different section angles 10 between pressure side and counter-pressure side, different dimensions in the skirt wall sections 4a, 4b, different thicknesses d in the skirt wall sections 4a, 4b between the pressure side and the counter-pressure side, different widths b in the box walls 5 between the pressure side and the counter-pressure side, different dimensions in the collar 11 perpendicular to the direction of the path of the pin boss 9 and parallel to the path of the box walls 5, different paths for the ribs 13 towards the path of the pin boss perpendicular and/or parallel to the line of the piston head 2, different connections from the area of the rear wall of the ring zone 3 to the area of the rear wall of the piston head 2 and/or of different dimensions for the ribs 13 on their path from the pressure side to the counter-pressure side. An asymmetrical piston 1 of this type is not shown in FIGS. 1 to 4.

The internal combustion engine further has a connecting rod, not shown in FIGS. 1 to 4, cooperating with the piston 1 described above, that has a shape to which the concave path of the respective box wall 5 of the piston 1 is correspondingly matched. The connecting rod has, in addition, an eye to receive a piston pin. The connecting rod further has an additional eye that receives the crankshaft of the internal combustion engine. The connecting rod eye to receive the piston pin in the embodiment has a smaller diameter compared with the connecting rod eye that receives the crankshaft.

The connecting rod further has a trapezoidal shape in the area of the smaller connecting rod eye, where this smaller connecting rod eye receives the piston pin, so that the connecting rod using a piston pin that is inserted through the pin bosses 9 of the piston 1 and the smaller connecting rod eye is movably locatable to the piston 1, or the box walls 5 (not shown in FIGS. 1 to 4). The connecting rod preferably has a straight trapezoidal shape in the area of the smaller connecting rod eye. A straight trapezoidal shape means that the surfaces of the trapezoid are straight. In contrast, for example the box wall 5 has a concave curve along its length. Using the surfaces of the connecting rod, the smallest spacing between the respective box wall 5 and trapezoidal connecting rod in the area of the smaller connecting rod eye can be determined. The shape of the respective box wall 5 is matched to this smallest spacing in the area of the middle of the piston 1 with regard to the connecting rod.

The connecting rod has a trapezoidal shape that extends between 8° and 25°, or between 15° and 20°. The angle is measured between the longer of the two sides of the trapezoid lying parallel to each other and one side of the trapezoid at a time.

Since the shape of the connecting rod determines the shape and location of the two box walls 5, the pin boss 9 of the respective box wall 5 also has a corresponding trapezoidal shape. In accordance with FIG. 1, the box walls 5 in the area of the piston head 2 follow a path roughly parallel to the stroke axis 6 viewed towards the stroke axis 6 and in the area of the respective pin boss 9 a path matched to the connecting rod shape viewed towards the stroke axis 6. The one area blends into the other area.

At least in the area of the smallest spacing between the connecting rod and the respective box wall 5 in the area of the pin boss 9, the shape of the trapezoidal connecting rod bevel is approximately the same or exactly the same as the shape of the respective pin boss 9 and the associated box wall 5. The shape of the particular box wall 5 with the appropriate pin boss 9 no longer has a trapezoidal shape with increasing distance to the smallest spacing towards the outer side of the piston, that is, in the present instance parallel to the direction of the specific box wall 5 and perpendicular to the pin axis 8.

What is claimed:

1. Piston (10) of an internal combustion engine having a piston head (2) a ring zone (3) and a skirt section attached to the piston head, where the skirt section has at least two load-bearing skirt wall sections (4a, 4b) and the load-bearing skirt wall sections (4a, 4b) are connected to each other via at least two oblique box walls (5) recessed with respect to the piston outside diameter, where a piston pin boss (9) is located in each to receive a piston pin and the one skirt wall section (4a) forms the pressure side and the other skirt wall section (4b) forms the counter-pressure side, characterized in that the internal surface of the pin boss (9) with regard to the piston center runs flush with the surface of the associated box wall (5) and the box wall (5) follows a concave path perpendicular to the direction of the pin boss (9).

2. Piston (1) from claim 1, wherein the two box walls (5) have a concave, preferably a mutually mirror-image concave path such that an approximately uniform X-shaped form results so that an approximately symmetrical piston is the result.

3. Piston (1) from claim 1 or claim 2, wherein the section angle (10) formed from the respective skirt wall section (4a, 4b) between pressure side and counter-pressure side is the same so that as a result the X-shape of the box walls (5) follows a regular path and thus the result is an approximately symmetrical piston (1).

4. Piston (1) from one of the claims 1 to 3, wherein the dimensions of the skirt wall sections (4a, 4b) are the same so that the result is an approximately symmetrical piston (1).

5. Piston (1) from one of the claims 1 to 4, wherein the thickness (d) of the skirt wall sections (4a, 4b) between pressure side and counter-pressure side is the same so that the result is an approximately symmetrical piston (1).

6. Piston (1) from one of the claims 1 to 5, wherein the width (b) of the box walls (5) between pressure side and counter-pressure side is the same so that the result is an approximately symmetrical piston (1).

7. Piston (1) from one of the claims 1 to 6, wherein the pin boss (9) projects from the associated box wall (5) towards the outer side of the piston.

8. Piston (1) from one of the claims 1 to 7, wherein the pin boss (9) projects from the box wall (5) on the opposite side of the piston head (2) at the box wall (5).

9. Piston (1) from one of the claims 1 to 8, wherein on the opposite side of the piston head (2) the surface of the box wall (5) towards the outer side of the piston has a collar (11) at the box wall (5) that reinforces the box wall (5) to absorb lateral forces.

10. Piston (1) from claim 9, wherein the collar (11) perpendicular to the direction of the path of the pin boss (9) and parallel to the path of the box walls (5) has the same dimensions so that the same collar shape results between pressure side and counter-pressure side, which creates an approximately symmetrical piston (1).

11. Piston (1) from one of the claims 1 to 10, wherein the piston head (2) has at least one undercut (12) partially encircling the piston (1) that is reinforced by at least one rib (13).

12. Piston (1) from claim 11, wherein the rib (13) has a wave-shaped, preferably a sinusoidal, wave-like path towards the path of the pin boss (9) parallel to the line of the piston head (2).

13. Piston (1) from claim 11 or 12, wherein the rib (13) has a wave-shaped, preferably a sinusoidal, wave-like path towards the line of the pin bosses (9) perpendicular to the line of the piston head (2).

14. Piston (1) from one of the claims 11 to 13, wherein the rib (13) has the same dimensions along its path so that an approximately symmetrical piston (1) is the result.

15. Piston (1) from one of the claims 11 to 14, wherein the thickness (d) of the rib (13) is the same in its path between pressure side and counter-pressure side so that an approximately symmetrical piston (1) is the result.

16. Piston (1) from one of the claims 1 to 15, wherein the at least one connection from the area of the ring zone (3) to the area of the piston head (2) is the same so that an approximately symmetrical piston (1) is the result.

17. Piston from one of the claims 1 to 16, wherein the piston (1) consists of at least two components, where one component comprises at least the piston head (2) and the other component at least the box walls (5), where the area between the box walls (5) and the piston head (2) has at least one type of connection.

18. Piston (1) from one of the claims 1 to 17, wherein the interior shape of the piston can be produced using a single-piece core, specifically can be cast.

19. Piston (1) from one of the claim 1, 7, 8, 9, 11, 12, 13, 17 or 19, wherein the section angles (10) between pressure side and counter-pressure side of the piston (1) are different so that the result is an asymmetrical piston (1).

20. Piston (1) from one of the claim 1, 7, 8, 9, 11, 12, 13, 17, 18 or 19, wherein the dimensions of the skirt wall sections (4a, 4b) of the piston (1) are different so that the result is an asymmetrical piston (1).

21. Piston (1) from one of the claim 1, 7, 8, 9, 11, 12, 13, 17, 18, 19 or 20, wherein the thickness (d) of the skirt wall sections (4a, 4b) of the piston (1) between pressure side and counter-pressure side is different so that the result is an asymmetrical piston.

22. Piston (1) from one of the claim 1, 7, 8, 9, 11, 12, 13, 17, 18, 19, 20 or 21, wherein the width (b) of the box walls (5) between pressure side and counter-pressure side is different so that the result is an asymmetrical piston.

23. Piston (1) from one of the claim 1, 7, 8, 9, 11, 12, 13, 17, 18, 19, 20, 21 or 22 wherein the dimensions of the collar (11) perpendicular to the direction of the line of the pin boss (9) and parallel to the path of the box walls (5) are different so that the result is an asymmetrical piston (1).

24. Piston (1) from one of the claim 1, 7, 8, 9, 11, 12, 13, 17, 18, 19, 20, 21, 22 or 23, wherein the path of the rib (13) towards the path of the pin boss (9) perpendicular and/or parallel to the line of the piston head (2) is different so that the result is an asymmetrical piston (1).

25. Piston (1) from one of the claim 1, 7, 8, 9, 11, 12, 13, 17, 18, 19, 20, 21, 22, 23 or 24, wherein the dimensions of the rib (13) in its path between pressure side and counter-pressure side are different so that the result is an asymmetrical piston (1).

26. Piston (1) from one of the claim 1, 7, 8, 9, 11, 12, 13, 17, 18, 19, 20, 21, 22, 23, 24 or 25, wherein the thickness (d) of the rib (13) in its path between pressure side and counter-pressure side is different so that the result is an asymmetrical piston (1).

27. Piston (1) from one of the claim 1, 7, 8, 9, 11, 12, 13, 17, 18, 19, 20, 21, 22, 23, 24, 25 or 26, wherein the at least one connection from the area of the ring zone (3) to the area of the piston head (2) is different so that the result is an asymmetrical piston (1).

28. Piston (1) from one of the claim 1, 7, 8, 9, 11, 12, 13, 17, 18, 19, 20, 21, 22, 23, 24, 25, 26 or 27, wherein the two box walls (5) follow a concave path such that a somewhat irregular X-shape results because of the two box walls (5) so that the result is an asymmetrical piston (1).

29. Connecting rod of an internal combustion engine, having a connecting rod eye to receive a piston pin, where the connecting rod cooperates with the piston (1) in accordance with one of the claims 1 to 28, characterized in that the connecting rod has a shape to which the concave path of the specific box wall is matched.

30. Connecting rod from claim 29, wherein the connecting rod has a trapezoidal shape in the area of the connecting rod eye, where this connecting rod eye accommodates the piston pin.

31. Connecting rod from claim 30, wherein the angle of the trapezoidal shape of the connecting rod extends between 8° and 25°, preferably between 15° and 20° for each side of the trapezoid.
